(19) United States
(12) Patent Application Publication
(10) Pub. No.: US 2026/0177828 A1
(43) Pub. Date: Jun. 25, 2026

(54) NEAR-EYE DISPLAY ASSEMBLY

(71) Applicant: SEEYA OPTRONICS CO., LTD., Shanghai (CN)

(72) Inventors: Shuangshuang MA, Shanghai (CN); Bo LIU, Shanghai (CN); Lei NIU, Shanghai (CN)

(73) Assignee: SEEYA OPTRONICS CO., LTD., Shanghai (CN)

(21) Appl. No.: 19/181,508

(22) Filed: Apr. 17, 2025

(30) Foreign Application Priority Data
Dec. 23, 2024 (CN) 202411917746.9

(51) Int. Cl. G02B 27/01; G02B 27/00

(52) U.S. Cl. CPC G02B 27/0172; G02B 27/0081; G02B 27/0176; G02B 2027/011; G02B 2027/0116; G02B 2027/015; G02B 2027/0152

(57) ABSTRACT

A near-eye display assembly includes a one-dimensional optical waveguide and an optical system, and the one-dimensional optical waveguide includes an in-coupling region and an out-coupling region. The optical system is arranged towards the in-coupling region of the one-dimensional optical waveguide. The optical system includes a display screen and a refraction and reflection imaging system. The refraction and reflection imaging system is located at a light-emitting side of the display screen, and the display screen is located on an object side focal plane of the refraction and reflection imaging system. The refraction and reflection imaging system includes a first catadioptric surface and a second catadioptric surface arranged along the optical axis, and at least part of light rays emitted from any position on the display screen are sequentially transmitted through the first catadioptric surface to the second catadioptric surface.

### CROSS-REFERENCE TO RELATED APPLICATION

This application claims priority to Chinese Patent Application No. 202411917746.9 filed Dec. 23, 2024, the disclosure of which is incorporated herein by reference in its entirety.

### TECHNICAL FIELD

Embodiments of the present disclosure relate to the field of display technology, and more particularly to a near-eye display assembly.

### BACKGROUND

In conventional coupling optical system for one-dimensional optical waveguides, the solutions including direct transmission with multiple lenses or TIR prism-based light path folding may generally be adopted for the in-coupling part. The multiple lenses solution generally adopts a glass structure, a glass-plastic mixed structure or a pure plastic structure, but the those structures are large in size and weight, and can only achieve very limited field of view, which cannot meet the requirements of light wearing. The TIR prism solution can achieve a small volume and meet the requirements of lightness, but it generally needs to match a free-form surface and therefore has a high processing cost. In addition, since it is difficult to correct chromatic aberration of the TIR prism, the TIR prism has a large chromatic aberration for complex light, which adversely affects the actual viewing experience. Furthermore, the conventional in-coupling optical system for a one-dimensional optical waveguide, when designed to meet the requirements of a large field of view, inevitably face the significant drawbacks of large volume and heavy weight. These issues degrade the consumer experience in practical applications.

In general, the conventional in-coupling optical system for a one-dimensional optical waveguide cannot simultaneously achieve the advantages of small size, large field of view, low aberration, large pupil, etc., and when it is worn for a long time, lightness becomes the most in-demand feature.

### SUMMARY

A near-eye display assembly is provided according to the present disclosure to solve the problems of an in-coupling optical system for a one-dimensional optical waveguide being bulky and having a small field of view.

In a first aspect, a near-eye display assembly is provided according to embodiments of the present disclosure, which includes: a one-dimensional optical waveguide and an optical system.

The one-dimensional optical waveguide includes an in-coupling region and an out-coupling region which are arranged in a first direction, and the first direction is a pupil expansion direction of the one-dimensional optical waveguide.

The optical system is arranged toward the in-coupling region of the one-dimensional optical waveguide. The optical system includes a display screen and a refraction and reflection imaging system, the refraction and reflection imaging system is located on a light-emitting side of the display screen, and the display screen is located on an object side focal plane of the refraction and reflection imaging system.

The refraction and reflection imaging system includes a first catadioptric surface and a second catadioptric surface which are arranged along an optical axis. At least part of light rays emitted from any position on the display screen are transmitted through the first catadioptric surface to the second catadioptric surface, reflected from the second catadioptric surface to the first catadioptric surface, reflected from the first catadioptric surface to the second catadioptric surface, and transmitted through the second catadioptric surface to the in-coupling region of the one-dimensional optical waveguide in sequence.

Optionally, the refraction and reflection imaging system includes a lens subsystem, the lens subsystem includes at least a first lens, the first catadioptric surface is located on an object side surface of the first lens, and the second catadioptric surface is located on an image side surface of the first lens.

The first catadioptric surface includes a first transmission region and a first reflection region, the first reflection region surrounds the first transmission region; and the second catadioptric surface includes a second transmission region and a second reflection region, and the second transmission region surrounds the second reflection region.

In an optical axis direction, a projection of the display screen is located within a projection of the first transmission region, and the projection of the first transmission region is located within a projection of the second reflection region.

At least part of the light rays emitted from any position on the display screen are transmitted through the first transmission region to the second reflection region, reflected from the second reflection region to the first reflection region, reflected from the first reflection region to the second transmission region, and transmitted through the second transmission region to the in-coupling region of the one-dimensional optical waveguide.

Optionally, the first transmission region of the object side surface of the first lens is provided with a first transmission film, and the first reflection region is provided with a first reflection film.

The second transmission region of the image side surface of the first lens is provided with a second transmission film, and the second reflection region is provided with a second reflection film.

Optionally, the refraction and reflection imaging system includes a first plane and a second plane, and the first plane and the second plane are perpendicular to each other and intersect at the optical axis of the refraction and reflection imaging system.

Each of the first transmission region, the first reflection region, the second transmission region and the second reflection region is self-symmetrical relative to the first plane, and is also self-symmetrical relative to the second plane.

h>A; H21c1<H/2<H21a2, where A denotes the length of an intersection line between the display screen and the first plane; and h denotes the length of an intersection line between the first transmission region and the first plane, and H denotes the length of an intersection line between the second reflection region and the first plane.

H21c1 denotes the distance between the optical axis and a point, closest to the optical axis, of a third edge projection region in the first plane, and the third edge projection region is a projection region of an exit light beam, emitted from an edge point of the display screen on the first plane, on the second catadioptric surface for a first time.

H21a2 denotes the distance between the optical axis and a point, farthest from the optical axis, of a fourth edge projection region in the first plane, and the fourth edge projection region is a projection region of an exit light beam, emitted from an edge point of the display screen on the first plane, on the second catadioptric surface for a second time.

v>B; V21f1<V/2<V21d2, and D<V<D₀. B denotes the length of an intersection line between the display screen and the second plane; and v denotes the length of an intersection line between the first transmission region and the second plane, and V denotes the length of an intersection line between the second reflection region and the second plane.

V21f1 denotes the distance between the optical axis and a point, closest to the optical axis, of a seventh edge projection region in the second plane, and the seventh edge projection region is a projection region of an exit light beam, emitted from an edge point of the display screen on the second plane, on the second catadioptric surface for the first time.

V21d2 denotes the distance between the optical axis and a point, farthest from the optical axis, of an eighth edge projection region in the second plane; and the eighth edge projection region is a projection region of the exit light beam, emitted from an edge point of the display screen on the second plane, on the second catadioptric surface for the second time.

D denotes the diameter of a field of view formed by an exit light beam, from an edge point farthest, from a center point on the display screen, through the lens subsystem on the image side focal plane; and D₀ denotes the diameter of a field of view formed by an exit light beam, from the center point on the display screen, through the lens subsystem on the image side focal plane.

Optionally, H21c1<H/2<H21c2, and h22c1<h/2<h22c2; or, H21a1<H/2<H21a2, h22a1<h/2<h22a2.

H21c1 denotes the distance between the optical axis and a point, closest to the optical axis, of the third edge projection region in the first plane, and the third edge projection region is a projection region of an exit light beam, emitted from an edge point of the display screen on the first plane, on the second catadioptric surface for the first time.

H21c2 denotes the distance between the optical axis and a point, closest to the optical axis, of the fourth edge projection region in the first plane, and the fourth edge projection region is a projection region of an exit light beam, emitted from an edge point of the display screen on the first plane, on the second catadioptric surface for the second time.

h22c1 denotes the distance between the optical axis and a point, closest to the optical axis, of a first edge projection region in the first plane, and the first edge projection region is a projection region of an exit light beam, emitted from an edge point of the display screen on the first plane, on the first catadioptric surface for the first time.

h22c2 denotes the distance between the optical axis and a point, closest to the optical axis, of a second edge projection region in the first plane; and the second edge projection region is a projection region of an exit light beam, emitted from an edge point of the display screen on the first plane, on the first catadioptric surface for the second time.

H21a1 denotes the distance between the optical axis and a point, farthest from the optical axis, of the third edge projection region in the first plane.

H21a2 denotes the distance between the optical axis and a point, farthest from the optical axis, of the fourth edge projection region in the first plane.

h22a1 denotes the distance between the optical axis and a point, farthest from the optical axis, of the first edge projection region in the first plane.

h22a2 denotes the distance between the optical axis and a point, farthest from the optical axis, of the second edge projection region in the first plane.

Optionally, V21f1<V/2<V21f2, and v22f1<v/2<v22f2; or, V21d1<V/2<V21d2, and v22d1<v/2<v22d2.

V21f1 denotes the distance between the optical axis and a point, closest to the optical axis, of the seventh edge projection region in the second plane, and the seventh edge projection region is a projection region of an exit light beam, emitted from an edge point of the display screen on the second plane, on the second catadioptric surface for the first time.

V21f2 denotes the distance between the optical axis and a point, closest to the optical axis, of the eighth edge projection region in the second plane; and the eighth edge projection region is a projection region of an exit light beam, emitted from an edge point of the display screen on the second plane, on the second catadioptric surface for the second time.

v22f1 denotes the distance between the optical axis and a point, closest to the optical axis, of a fifth edge projection region in the second plane; and the fifth edge projection region is a projection region of an exit light beam, emitted from an edge point of the display screen on the second plane, on the first catadioptric surface for the first time.

v22f2 denotes the distance between the optical axis and a point, closest to the optical axis, of a sixth edge projection region in the second plane; and the sixth edge projection region is a projection region of an exit light beam, emitted from an edge point of the display screen on the second plane, on the first catadioptric surface for the second time.

V21d1 denotes the distance between the optical axis and a point, farthest from the optical axis, of the seventh edge projection region in the second plane.

V21d2 denotes the distance between the optical axis and a point, farthest from the optical axis, of the eighth edge projection region in the second plane.

v22d1 denotes the distance between the optical axis and a point, farthest from the optical axis, of the fifth edge projection region in the second plane.

v22d2 denotes the distance between the optical axis and a point, farthest from the optical axis, of the sixth edge projection region in the second plane.
V11d1<V/2<V11d2, and v12d1<v/2<v12d2.

V11d1 denotes the distance between the optical axis and a point, farthest from the optical axis, of a seventh central projection region in the second plane; and the seventh central projection region is a projection region of an exit light beam, emitted from the center point of the display screen on the second plane, on the second catadioptric surface for the first time.

V11d2 denotes the distance between the optical axis and a point, farthest from the optical axis, of an eighth central projection region in the second plane; and the eighth central projection region is a projection region of an exit light beam, emitted from the center point of the display screen on the second plane, on the second catadioptric surface for the second time.

v12d1 denotes the distance between the optical axis and a point, farthest from the optical axis, of a fifth central projection region in the second plane; and the fifth central projection region is a projection region of an exit light beam, emitted from the center point of the display screen on the second plane, on the first catadioptric surface for the first time.

v12d2 denotes the distance between the optical axis and a point, farthest from the optical axis, of a sixth central projection region in the second plane.

Optionally, 2 mm<D<8 mm and 2 mm<D₀<8 mm.

Optionally, projections of the first transmission region and the second reflection region in the optical axis direction have a same shape, and the shape includes rectangular, elliptical or irregular polygonal.

Optionally, the refraction and reflection imaging system includes a transmissive polarizer, a first quarter-wave plate, a lens subsystem, a second quarter-wave plate and a reflective polarizer arranged in sequence along the optical axis.

The lens subsystem includes at least a first lens, and the first catadioptric surface is located on an object side surface of the first lens; the first catadioptric surface includes a first transmission region and a first reflection region, and the first reflection region surrounds the first transmission region; and the second catadioptric surface is located on the reflective polarizer.

In the optical axis direction, a projection of the display screen is located within a projection of the first transmission region.

At least part of the light rays emitted from any position on the display screen sequentially pass through the transmissive polarizer, the first quarter wave plate, the first transmission region, the second quarter wave plate, the reflective polarizer, the second quarter wave plate, the first reflection region, the second quarter wave plate, and the reflective polarizer to enter the in-coupling region of the one-dimensional optical waveguide.

During transmission of the light rays from the display screen to the in-coupling region of the one-dimensional optical waveguide, horizontally polarized light is formed after the light rays from the display screen pass through the transmissive polarizer, right-handed circularly polarized light is formed after the light rays from the transmissive polarizer pass through the first quarter wave plate, the horizontally polarized light is formed after the light rays transmitted from the first transmission region pass through the second quarter wave plate, light rays from the second quarter wave plate are reflected by the reflective polarizer to pass through the second quarter wave plate to form the right-handed circularly polarized light, the left-handed circularly polarized light is formed after the light rays from the second quarter wave plate are reflected by the first reflection region, vertical polarized light is formed after the light rays reflected by the first reflection region pass through the second quarter wave plate, and finally the light rays from the second quarter wave plate are transmitted through the reflective polarizer to the in-coupling region of the one-dimensional optical waveguide.

Optionally, the first transmission region of the object side surface of the first lens is provided with a first transmission film, and the first reflection region is provided with a first reflection film.

Optionally, the refraction and reflection imaging system includes a first plane and a second plane, and the first plane and the second plane are perpendicular to each other and intersect at the optical axis of the refraction and reflection imaging system.

Each of the first transmission region and the first reflection region is self-symmetrical relative to the first plane, and is also self-symmetrical relative to the second plane.
h>A; v>B.
where, h denotes the length of an intersection line between the first transmission region and the first plane.

A denotes the length of an intersection line between the display screen and the first plane.

v denotes the length of an intersection line between the first transmission region and the second plane.

B denotes the length of an intersection line between the display screen and the second plane.

Optionally, h22c1<h/2<h22c2; or, h22a1<h/2<h22a2.

h22c1 denotes the distance between the optical axis and a point, closest to the optical axis, of a first edge projection region in the first plane; and the first edge projection region is a projection region of an exit light beam, emitted from an edge point of the display screen on the first plane, on the first catadioptric surface for the first time.

h22c2 denotes the distance between the optical axis and a point, closest to the optical axis, of a second edge projection region in the first plane; and the second edge projection region is a projection region of an exit light beam, emitted from an edge point of the display screen on the first plane, on the first catadioptric surface for the second time.

h22a1 denotes the distance between the optical axis and a point, farthest from the optical axis, of the first edge projection region in the first plane; and the first edge projection region is a projection region of an exit light beam, emitted from an edge point of the display screen on the first plane, on the first catadioptric surface for the first time.

h22a2 denotes the distance between the optical axis and a point, farthest from the optical axis, of the second edge projection region in the first plane; and the second edge projection region is a projection region of an exit light beam, emitted from an edge point of the display screen on the first plane, on the first catadioptric surface for the second time.
h12a1<h/2<h12a2.

h12a1 denotes the distance between the optical axis and a point, farthest from the optical axis, of a first central projection region in the first plane; and the first central projection region is a projection region of an exit light beam, emitted from a center point of the display screen on the first plane, on the first catadioptric surface for the first time.

h12a2 denotes the distance between the optical axis and a point, farthest from the optical axis, of a second central projection region in the first plane; and the second central projection region is a projection region of an exit light beam, emitted from the center point of the display screen on the first plane, on the first catadioptric surface for the second time.

Optionally, v22f1<v/2<v22f2; or, v22d1<v/2<v22d2.

v22f1 denotes the distance between the optical axis and a point, closest to the optical axis, of a fifth edge projection region in the second plane; and the fifth edge projection region is a projection region of an exit light beam, emitted from an edge point of the display screen on the second plane, on the first catadioptric surface for the first time.

v22f2 denotes the distance between the optical axis and a point, closest to the optical axis, of a sixth edge projection region in the second plane; and the sixth edge projection region is a projection region of an exit light beam, emitted from an edge point of the display screen on the second plane, on the first catadioptric surface for the second time.

v22d1 denotes the distance between the optical axis and a point, farthest from the optical axis, of the fifth edge projection region in the second plane; and the fifth edge projection region is a projection region of an exit light beam, emitted from an edge point of the display screen on the second plane, on the first catadioptric surface for the first time.

v22d2 denotes the distance between the optical axis and a point, farthest from the optical axis, of the sixth edge projection region in the second plane; and the sixth edge projection region is a projection region of an exit light beam, emitted from an edge point of the display screen on the second plane, on the first catadioptric surface for the second time.
v12d1<v/2<v12d2.

v12d1 denotes the distance between the optical axis and a point, farthest from the optical axis, of a fifth central projection region in the second plane; and the fifth central projection region is a projection region of an exit light beam, emitted from the center point of the display screen on the second plane, on the first catadioptric surface for the first time.

v12d2 denotes the distance between the optical axis and a point, farthest from the optical axis, of a sixth central projection region in the second plane; and the sixth central projection region is a projection region of an exit light beam, emitted from the center point of the display screen on the second plane, on the first catadioptric surface for the second time.

Optionally, the first lens is a meniscus lens convex toward the display screen.

Optionally, the object side surface or the image side surface of the first lens is a spherical surface, an aspherical surface, a free-form surface or a diffraction surface.

Optionally, the refraction and reflection imaging system has positive focal power.

In the technical solution according to the embodiments of the present disclosure, the near-eye display assembly includes the one-dimensional optical waveguide and the optical system. The one-dimensional optical waveguide includes the in-coupling region and the out-coupling region, and the in-coupling region and the out-coupling region are arranged in the first direction, and the first direction is the pupil expansion direction of the one-dimensional optical waveguide. The optical system is arranged towards the in-coupling region of the one-dimensional optical waveguide. The optical system includes the display screen and the refraction and reflection imaging system, the refraction and reflection imaging system is located on the light emitting side of the display screen, and the display screen is located on the object side focal plane of the refraction and reflection imaging system. The refraction and reflection imaging system includes the first catadioptric surface and the second catadioptric surface arranged along the optical axis, and at least part of the light rays emitted from any position on the display screen are transmitted through the first catadioptric surface to the second catadioptric surface, reflected from the second catadioptric surface to the first catadioptric surface, reflected from the first catadioptric surface to the second catadioptric surface, and transmitted through the second catadioptric surface to the in-coupling region of the one-dimensional optical waveguide in sequence. The embodiments of the present disclosure solve the problems that the in-coupling optical system of the one-dimensional optical waveguide cannot be compatible with the advantages of small size, large field of view, small aberration, large pupil, etc., and has the problems of bulkiness and small field of view. The light rays are reflexed by the refraction and reflection imaging system, which reduces the distance between the display screen and the one-dimensional optical waveguide, reduces the volume and weight of the optical system, and also increases the field of view, increases the pupil, reduces the user's eye fatigue, and effectively improves the user's experience during actual use.

### BRIEF DESCRIPTION OF DRAWINGS

FIG. 1 is a schematic diagram of the structure of a near-eye display assembly in an XOZ plane according to an embodiment of the present disclosure;

FIG. 2 is a schematic diagram of the structure of the near-eye display assembly shown in FIG. 1 in an YOZ plane;

FIG. 3 is a schematic diagram of the structure of another near-eye display assembly according to an embodiment of the present disclosure in the YOZ plane;

FIG. 4 and FIG. 5 are schematic diagrams of beam reflex projection region in two planes according to an embodiment of the present disclosure;

FIG. 6 to FIG. 8 show three types of dimensional design schematics for transmission and reflection of the near-eye display assembly according to an embodiment of the present disclosure;

FIG. 9 to FIG. 13 show five types of dimensional design schematics for transmission and reflection of the near-eye display assembly according to an embodiment of the present disclosure;

FIG. 14 is a schematic diagram of the equivalent structure of another near-eye display assembly according to an embodiment of the present disclosure in the YOZ plane; and

FIG. 15 to FIG. 20 show six types of dimensional design schematics for transmission and reflection of the near-eye display assembly according to an embodiment of the present disclosure.

### DETAILED DESCRIPTION

The present disclosure is further described in detail hereinafter in conjunction with the drawings and embodiments. It is to be understood that the embodiments described herein are only used to explain the present disclosure rather than limiting the present disclosure. It should also be noted that, for the convenience of description, only the parts related to the present disclosure rather than all structures are shown in the drawings.

The terms used in the embodiments of the present disclosure are only for the purpose of describing specific embodiments, and are not intended to limit the present disclosure. It should be noted that the directional words such as “upper”, “lower”, “left”, “right” and the like described in the embodiments of the present disclosure are described from the angles shown in the drawings, and should not be understood as limiting the embodiments of the present disclosure. Furthermore, it should be understood in the context that when it is mentioned that an element is formed “on” or “under” another element, it can not only be formed directly “on” or “under” another element, but also be formed indirectly “on” or “under” another element through an intermediate element. The terms “first”, “second” and the like are only used for descriptive purposes and do not indicate any order, quantity or importance, but are only used to distinguish different components. For the person of ordinary skills in the art, the specific meanings of the above terms in the present disclosure can be understood according to specific circumstances.

The term “including” and its variations used in the present disclosure are open inclusions, that is, “including but not limited to”. The term “based on” means “based at least in part on”. The term “one embodiment” means “at least one embodiment”.

It should be noted that the concepts of “first”, “second”, etc. mentioned in the present disclosure are only used to distinguish the corresponding contents, and are not used to limit the order or interdependence.

It should be noted that the modifications of “one” and “multiple” mentioned in the present disclosure are illustrative rather than restrictive. The person skilled in the art should understand that unless otherwise clearly stated in the context, they should be understood as “one or more”.

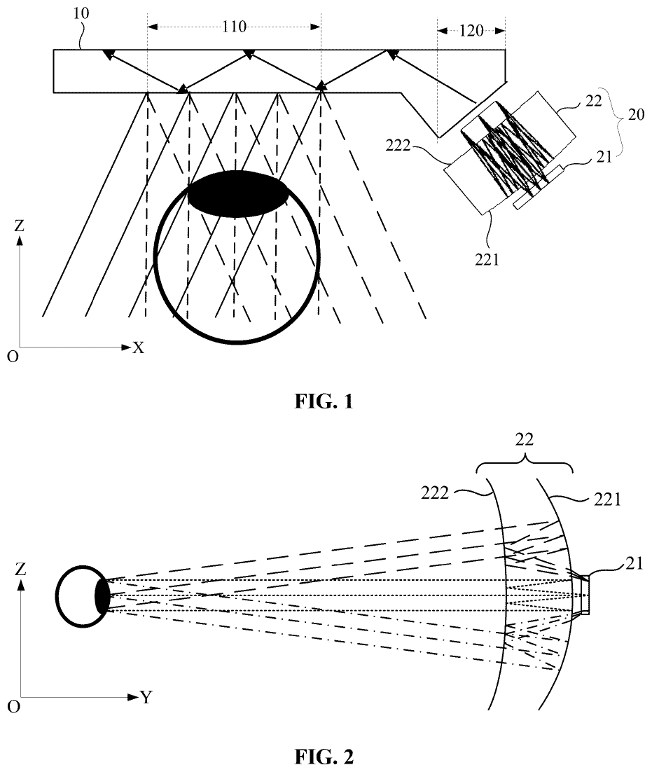

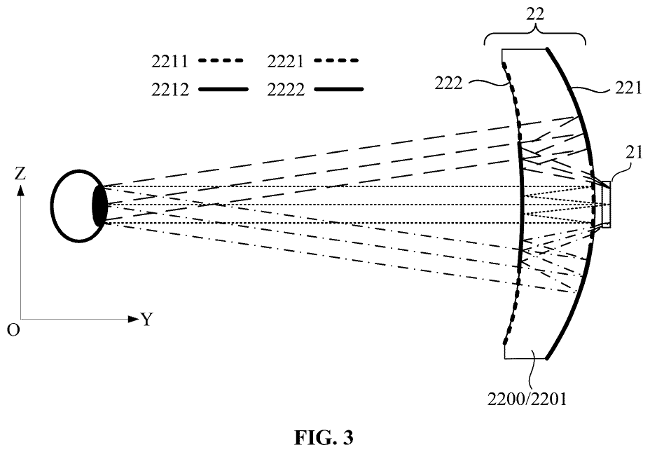

FIG. 1 is a schematic diagram of the structure of a near-eye display assembly according to an embodiment of the present disclosure in an XOZ plane, and FIG. 2 is a schematic diagram of the structure of the near-eye display assembly shown in FIG. 1 in an YOZ plane. Referring to FIG. 1 and FIG. 2, the near-eye display assembly includes a one-dimensional optical waveguide 10 and an optical system 20. The one-dimensional optical waveguide 10 includes an in-coupling region 110 and an out-coupling region 120, the in-coupling region 110 and the out-coupling region 120 are arranged in a first direction X, and the first direction X is a pupil expansion direction of the one-dimensional optical waveguide 10. The optical system 20 is arranged towards the in-coupling region 110 of the one-dimensional optical waveguide 10. The optical system 20 includes a display screen 21 and a refraction and reflection imaging system 22, the refraction and reflection imaging system 22 is located on a light-emitting side of the display screen 21, and the display screen 21 is located on an object side focal plane of the refraction and reflection imaging system 22.

The refraction and reflection imaging system 22 includes a first catadioptric surface 221 and a second catadioptric surface 222 arranged along the optical axis. At least part of light rays emitted from any position on the display screen 21 are sequentially transmitted through the first catadioptric surface 221 to the second catadioptric surface 222, reflected from the second catadioptric surface 222 to the first catadioptric surface 221, reflected from the first catadioptric surface 221 to the second catadioptric surface 222, and transmitted through the second catadioptric surface 222 to the in-coupling region 110 of the one-dimensional optical waveguide 10.

First, for ease of understanding, the three-dimensional space where the near-eye display assembly in this embodiment is located is defined by a first direction X, a second direction Y, and a third direction Z that are perpendicular to each other, thereby forming the XOZ plane and the YOZ plane. FIG. 1 is a view of the near-eye display assembly in the XOZ plane, and FIG. 2 is a view of the near-eye display assembly in the YOZ plane. As shown in FIG. 1 and FIG. 2, in the near-eye display assembly, the one-dimensional optical waveguide 10 is responsible for proportionally transferring the image projected by the optical system 20, and then transmitting the image to the human eye, thereby achieving a virtual display effect. A person skilled in the art can understand that the one-dimensional optical waveguide 10 refers to an optical device that constrains the propagation of light in a single dimension, specifically, restricts the propagation of light in the first direction X, but does not restrict in the second direction Y and the third direction Z. For the near-eye display assembly, the one-dimensional optical waveguide 10 can increase the field of view and the uniformity of the exit pupil, and its pupil expansion direction is the first direction X.

In an embodiment of the present disclosure, a display screen 21 and a refraction and reflection imaging system 22 are provided in the optical system 20, the display screen 21 is responsible for displaying the image, and the refraction and reflection imaging system 22 is responsible for projecting the image displayed by the display screen 21 to the in-coupling region 110 of the one-dimensional optical waveguide 10, and then transmitting the image to the human eye through the one-dimensional optical waveguide 10. The refraction and reflection type propagation mode of the light rays emitted from the display screen 21 in this process is also shown in FIG. 2. It can be understood that, compared with the direct transmission imaging system, the refraction and reflection imaging system 22 can shorten the distance between the display screen 21 and the human eye in the direction of the optical axis since it projects the image into the human eye in a refraction and reflection manner. In other words, it can also be understood that the refraction and reflection imaging system 22 may have a reduced overall structure and a shortened distance between the display screen 21 and the one-dimensional optical waveguide 10. Specifically, the first catadioptric surface 221 and the second catadioptric surface 222 may be provided in the refraction and reflection imaging system 22 to realize the refraction and reflection of the light rays. The first catadioptric surface 221 may allow the light rays projected from the display screen 21 to the corresponding position of the first catadioptric surface 221 to be transmitted, and the second catadioptric surface 222 may allow the light rays projected from the first catadioptric surface 221 to the corresponding region of the second catadioptric surface 222 to be reflected, and moreover, the first catadioptric surface 221 may further allow the light rays reflected from the second catadioptric surface 222 to the first catadioptric surface 221 to continue to be reflected, and the second catadioptric surface 222 may further allow the light rays reflected from the first catadioptric surface 221 to the second catadioptric surface 222 to be transmitted and enter the one-dimensional optical waveguide 10.

Optionally, in the embodiment of the present disclosure, the refraction and reflection imaging system 22 has positive focal power. It can be understood that in order to ensure the display of the entire imaging, the display screen 21 needs to be set on the optical axis. As shown in FIG. 2, the refracting and reflecting process of the exit light rays of the refraction and reflection imaging system 22 with positive focal power in the refraction and reflection imaging system 22 is essentially the process of diffusion and then convergence of light rays. Therefore, it can be seen that the light ray refracting and reflecting process in the refraction and reflection imaging system 22 is also the process of increasing the field of view and the pupil.

In the above technical solution, the near-eye display assembly includes the one-dimensional optical waveguide and the optical system. The one-dimensional optical waveguide includes the in-coupling region and the out-coupling region, and the in-coupling region and the out-coupling region are arranged in the first direction, and the first direction is the pupil expansion direction of the one-dimensional optical waveguide. The optical system is arranged towards the in-coupling region of the one-dimensional optical waveguide. The optical system includes the display screen and the refraction and reflection imaging system, the refraction and reflection imaging system is located on the light emitting side of the display screen, and the display screen is located on the object side focal plane of the refraction and reflection imaging system. The refraction and reflection imaging system includes the first catadioptric surface and the second catadioptric surface arranged along the optical axis, and at least part of the light rays emitted from any position on the display screen are transmitted through the first catadioptric surface to the second catadioptric surface, reflected from the second catadioptric surface to the first catadioptric surface, reflected from the first catadioptric surface to the second catadioptric surface, and transmitted through the second catadioptric surface to the in-coupling region of the one-dimensional optical waveguide in sequence. The embodiments of the present disclosure solve the problems that the in-coupling optical system of the one-dimensional optical waveguide cannot be compatible with the advantages of small size, large field of view, small aberration, large pupil, etc., and has the problems of bulkiness and small field of view. The light rays are reflexed by the refraction and reflection imaging system, which reduces the distance between the display screen and the one-dimensional optical waveguide, reduces the volume and weight of the optical system, and also increases the field of view, increases the pupil, reduces the user's eye fatigue, and effectively improves the user's experience during actual use.

Specifically, the embodiments of the present disclosure provide two specific implementations for the refraction and reflection imaging system, one is the Cassegrain Reflector System, and the other is the Polarization Reflective-Refractive System. The specific structure and implementation principle of the two refraction and reflection imaging systems are introduced below.

FIG. 3 is a schematic diagram of the structure of another near-eye display assembly according to an embodiment of the present disclosure in the YOZ plane. Referring to FIG. 1 and FIG. 3, in an embodiment, the refraction and reflection imaging system 22 includes a lens subsystem 2200, and the lens subsystem 2200 includes at least a first lens 2201, the first catadioptric surface 221 is located on an object side surface of the first lens 2201, and the second catadioptric surface 222 is located on an image side surface of the first lens 2201. The first catadioptric surface 221 includes a first transmission region 2211 and a first reflection region 2212, and the first reflection region 2212 surrounds the first transmission region 2211. The second catadioptric surface 222 includes a second transmission region 2221 and a second reflection region 2222, and the second transmission region 2221 surrounds the second reflection region 2222.

In the optical axis direction, the projection of the display screen 21 is located within the projection of the first transmission region 2211, and the projection of the first transmission region 2211 is located within the projection of the second reflection region 2222. At least part of the light rays emitted from any position on the display screen 21 are transmitted through the first transmission region 2211 to the second reflection region 2222, reflected from the second reflection region 2222 to the first reflection region 2212, reflected from the first reflection region 2212 to the second transmission region 2221, and transmitted through the second transmission region 2221 to the in-coupling region 110 of the one-dimensional optical waveguide 10 in sequence.

The refraction and reflection imaging system 22 in this embodiment is essentially a Cassegrain Reflector structure, the lens subsystem 2200 of the refraction and reflection imaging system 22 is mainly responsible for light converging and imaging, and moreover, corresponding transmission regions and reflection regions are set on the lens in the lens subsystem 2200 to control the transmission or reflection process of the lens surfaces to the light rays. In the lens subsystem 2200, optionally, a first lens 2201 is provided, and the object side surface and the image side surface of the first lens 2201 are each provided with a transmission region and a reflection region. Of course, in other embodiments of the present disclosure, the lens subsystem 2200 may alternatively include more than one lens, so that the first catadioptric surface 221 and the second catadioptric surface 222 that achieve the function of reflecting can be located on the front and rear surfaces of the same lens, or can be provided on two surfaces of different lenses.

Specifically, optionally, the first transmission region 2211 of the object side surface of the first lens 2201 is provided with a first transmission film, and the first reflection region 2212 is provided with a first reflection film; the second transmission region 2221 of the image side surface of the first lens 2201 is provided with a second transmission film, and the second reflection region 2222 is provided with a second reflection film. The transmission film refers to an enhanced transmission film or an anti-reflection film, which can enhance the transmittance of light rays through the surface. The reflection film can be a metal film, etc., which can avoid the transmission of light rays and increase the reflectivity.

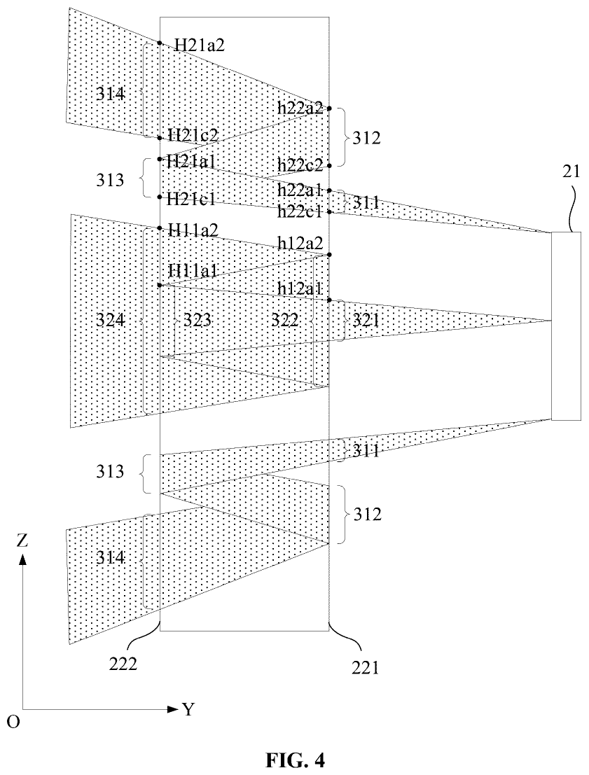

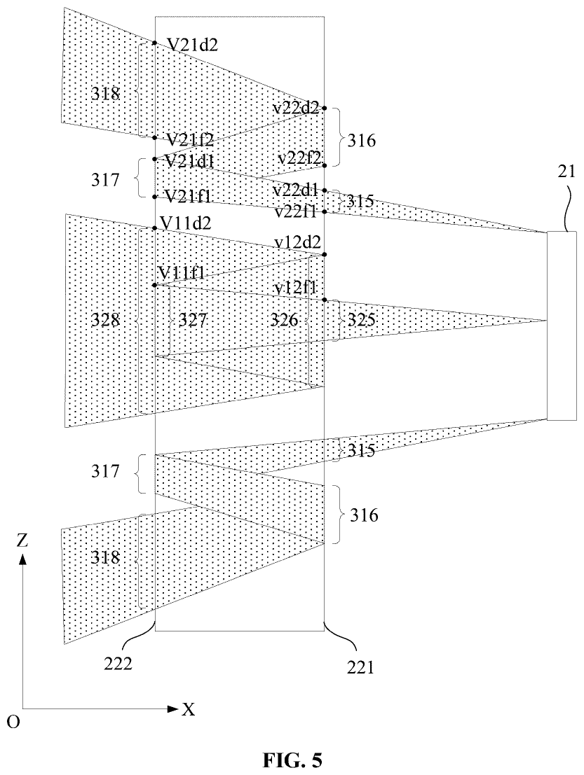

In order to ensure effective reflecting to allow the image displayed on the display screen 21 to effectively enter the human eye, it is further provided in this embodiment a regional range setting scheme for the transmission region and the reflection region on each of the two catadioptric surfaces. For a clear understanding, here, the projection regions of the exit light beam, emitted from a special position point of the display screen 21 on the two catadioptric surfaces when the light beam is reflected by the two catadioptric surfaces in theory, are taken as a reference and comparison standard to define the sizes of the two transmission regions and the two reflection regions accordingly. The theoretical definition standard here lies in that the light rays are transmitted when they are projected on the first catadioptric surface 221 for the first time, reflected when they are projected on the second catadioptric surface 222 for the first time, reflected when they are projected on the first catadioptric surface 221 for the second time, and transmitted when they are projected on the second catadioptric surface 222 for the second time. First, the light beams emitted from different position points on the display screen 21 each have a fixed exit angle, in other words, it can be understood as that all the light beams emitted from different position points on the display screen 21 in cone shapes will form corresponding projection regions in the reflexing process with the first catadioptric surface 221 and the second catadioptric surface 222. Furthermore, based on a fixed light beam exit angle, a fixed distance between the surfaces, and the refractive index of each structure in space, the regional position and area of the light beam when projected onto each of different surfaces can be known. FIG. 4 and FIG. 5 are schematic diagrams of the beam reflex projection regions on two planes according to an embodiment of the present disclosure. Referring to FIG. 4 and FIG. 5, projection regions of exit light beams, emitted from edge points of the display screen 21, on the two catadioptric surfaces are taken as edge projection regions, and the projection regions of exit light beams, emitted from the position points, on the two catadioptric surfaces for the two times are named as follows.

A projection region of an exit light beam, emitted from the edge point of the display screen 21 on the first plane YOZ, on the first catadioptric surface 221 for the first time is a first edge projection region 311.

A projection region of the exit light beam, emitted from the edge point of the display screen 21 on the first plane YOZ, on the first catadioptric surface 221 for the second time is a second edge projection region 312.

A projection region of the exit light beam, emitted from the edge point of the display screen 21 on the first plane YOZ, on the second catadioptric surface 222 for the first time is a third edge projection region 313.

A projection region of the exit light beam, emitted from the edge point of the display screen 21 on the first plane YOZ, on the second catadioptric surface 222 for the second time is a fourth edge projection region 314.

A projection region of an exit light beam, emitted from the edge point of the display screen 21 on the second plane XOZ, on the first catadioptric surface 221 for the first time is a fifth edge projection region 315.

A projection region of the exit light beam, emitted from the edge point of the display screen 21 on the second plane XOZ, on the first catadioptric surface 221 for the second time is a sixth edge projection region 316.

A projection region of the exit light beam, emitted from the edge point of the display screen 21 on the second plane XOZ Z, on the second catadioptric surface 222 for the first time is a seventh edge projection region 317.

A projection region of the exit light beam, emitted from the edge point of the display screen 21 on the second plane XOZ, on the second catadioptric surface 222 for the second time is an eighth edge projection region 318.

Projection regions of exit light beams, emitted from the center points of the display screen 21, on the two catadioptric surfaces are taken as central projection regions, and the projection regions of exit light beams, emitted from the position points, on the two catadioptric surfaces for the two times are named as follows.

A projection region of an exit light beam, emitted from the center point of the display screen 21 on the first plane YOZ, on the first catadioptric surface 221 for the first time is a first central projection region 321.

A projection region of the exit light beam, emitted from the center point of the display screen 21 on the first plane YOZ, on the first catadioptric surface 221 for the second time is a second central projection region 322.

A projection region of the exit light beam, emitted from the center point of the display screen 21 on the first plane YOZ, on the second catadioptric surface 222 for the first time is a third central projection region 323

A projection region of the exit light beam, emitted from the center point of the display screen 21 on the first plane YOZ, on the second catadioptric surface 222 for the second time is a fourth central projection region 324.

A projection region of an exit light beam, emitted from the center point of the display screen 21 on the second plane XOZ, on the first catadioptric surface 221 for the first time is a fifth central projection region 325.

A projection region of the exit light beam, emitted from the center point of the display screen 21 on the second plane XOZ, on the first catadioptric surface 221 for the second time is a sixth central projection region 326.

A projection region of the exit light beam, emitted from the center point of the display screen 21 on the second plane XOZ, on the second catadioptric surface 222 for the first time is a seventh central projection region 327.

A projection region of the exit light beam, emitted from the center point of the display screen 21 on the second plane XOZ, on the second catadioptric surface 222 for the second time is an eighth central projection region 328.

Specifically, the refraction and reflection imaging system 22 includes a first plane YOZ and a second plane XOZ, the first plane YOZ and the second plane XOZ are perpendicular to each other and intersect at the optical axis of the refraction and reflection imaging system 22. Each of the first transmission region 2211, the first reflection region 2212, the second transmission region 2221 and the second reflection region 2222 is self-symmetrical relative to the first plane YOZ, and is also self-symmetrical relative to the second plane XOZ.

Based on this, the sizes of the two transmission regions and the two reflection regions are defined as follows: h>A; H21c1<H/2<H21a2.

A denotes the length of the intersection line between the display screen 21 and the first plane YOZ. h denotes the length of the intersection line between the first transmission region 2211 and the first plane YOZ, and H denotes the length of the intersection line between the second reflection region 2222 and the first plane YOZ; H21c1 denotes the distance between the point, closest to the optical axis, of the third edge projection region 313 in the first plane YOZ. H21a2 denotes the distance between the point, farthest from the optical axis, of the fourth edge projection region 314 in the first plane YOZ.

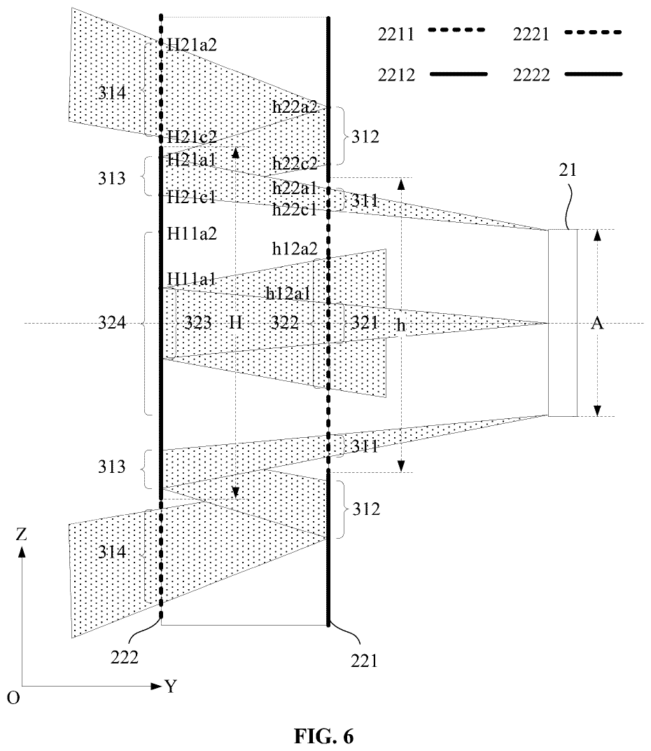

FIG. 6 to FIG. 8 show three types of dimensional design schematics for transmission and reflection of a near-eye display assembly according to an embodiment of the present disclosure. Referring to FIG. 6, according to the definition of each projection region, it can be understood that in the first plane YOZ, when h>A, it means that the length of the first transmission region 2211 is greater than the length of the display screen 21, thereby ensuring that all the light rays emitted from the display screen 21 can be transmitted when they are first projected onto the first catadioptric surface 221; and setting H21c1<H/2<H21a2 just means that the height of the boundary point of the second reflection region 2222 is between H21c1 and H21a2 when the position of the optical axis is taken as the origin, thereby ensuring that at least part of the light rays emitted from the edge point of the display screen 21 can be reflected when they reach the second catadioptric surface 222 for the first time, and transmitted when they reach the second catadioptric surface for the second time.

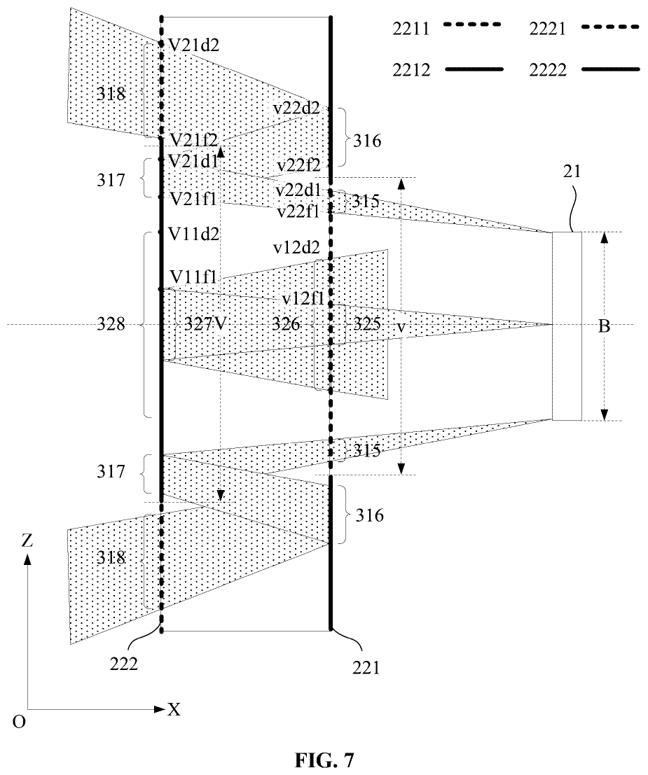

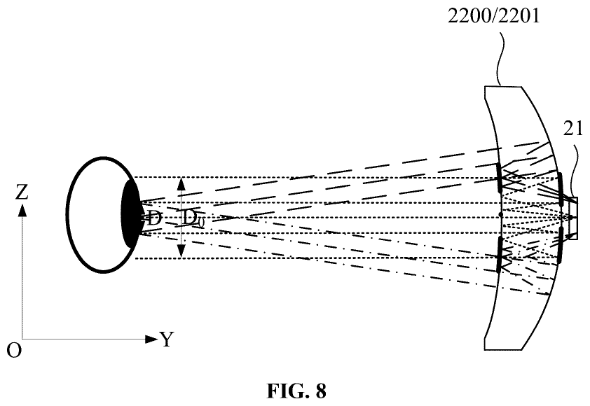

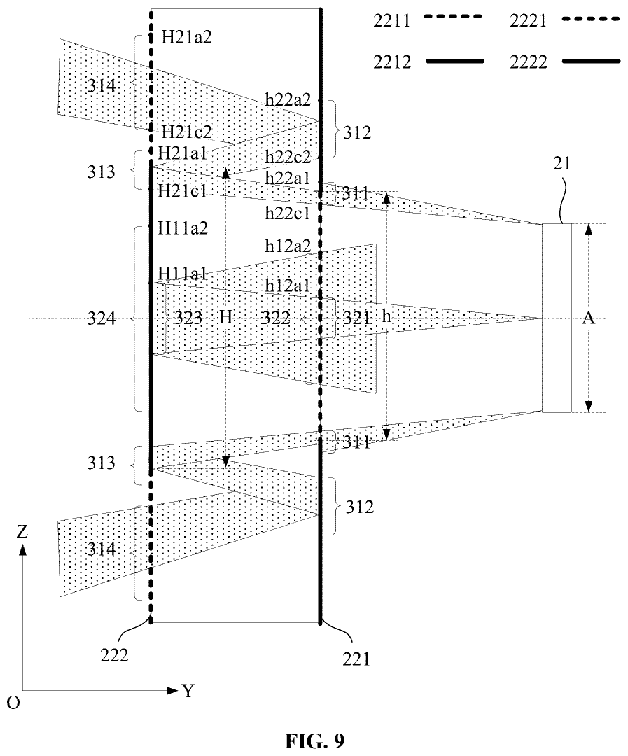

Referring to FIG. 7, v>B; V21f1<V/2<V21d2, and D<V<D₀. Herein, B denotes the length of the intersection line between the display screen and the second plane; v denotes the length of the intersection line between the first transmission region and the second plane, and V denotes the length of the intersection line between the second reflection region and the second plane. V21f1 denotes the distance between the point, closest to the optical axis, of the seventh edge projection region 317 in the second plane XOZ, and V21d2 denotes the distance between the point, farthest from the optical axis, of the eighth edge projection region 318 in the second plane XOZ. Referring to FIG. 8, D denotes the diameter of the field of view formed by the exit light beam, from the edge point farthest from the center point on the display screen, through the lens subsystem on the image side focal plane; and D₀ denotes the diameter of the field of view formed by the exit light beam, from the center point on the display screen, through the lens subsystem on the image side focal plane.

Referring to FIG. 7, similarly, according to the definition of each projection region, it can be understood that in the second plane XOZ, when v>B, it means that the length of the first transmission region 2211 is also greater than the length of the display screen 21, thereby ensuring that all the light rays emitted from the display screen 21 can be transmitted when they are first projected onto the first catadioptric surface 221; and setting V21f1<V/2<V21d2 also just means that the height of the boundary point of the second reflection region 2222 is between V21f1 and V21d2 when the position of the optical axis is taken as the origin, thereby ensuring that at least part of the light rays emitted from the edge point of the display screen 21 can be reflected when they reach the second catadioptric surface 222 for the first time, and transmitted when they reach the second catadioptric surface for the second time. Referring to FIG. 8, furthermore, by setting V satisfies D<V<D₀, that is, the size of the second reflection region 2222 is ensured to be larger than the field of view formed by the exit light beam, from the edge point farthest from the center point on the display screen, through the lens subsystem on the image side focal plane, and smaller than the diameter of the field of view formed by the exit light beam, from the center point on the display screen, through the lens subsystem on the image side focal plane. In this way, it can be ensured that the second reflection region 2222 will not completely block the light beams from these two position points, ensuring that the image of the display screen 21 is completely imaged in the human eye.

Specifically, 2 mm<D<8 mm and 2 mm<D₀<8 mm can be set. Although the pupil size of the human eye will change due to the influence of the ambient light intensity, it is basically within 2 mm to 8 mm. By setting the above size range to be not less than 2 mm and not more than 8 mm, the above size range can adapt to the actual pupil size of the human eye, thereby ensuring that the human eye can receive the exit light rays of the display screen 21, so that the image on the display screen is imaged in the human eye.

Further, referring to FIG. 9, H21c1<H/2<H21c2, and h22c1<h/2<h22c2; where H21c1 denotes the distance between the point, closest to the optical axis, of the third edge projection region 313 in the first plane YOZ, and H21c2 denotes the distance between the point, closest to the optical axis, of the fourth edge projection region 314 in the first plane YOZ, h22c1 denotes the distance between the point, closest to the optical axis, of the first edge projection region 311 in the first plane YOZ, and h22c2 denotes the distance between the point, closest to the optical axis, of the second edge projection region 312 in the first plane YOZ.

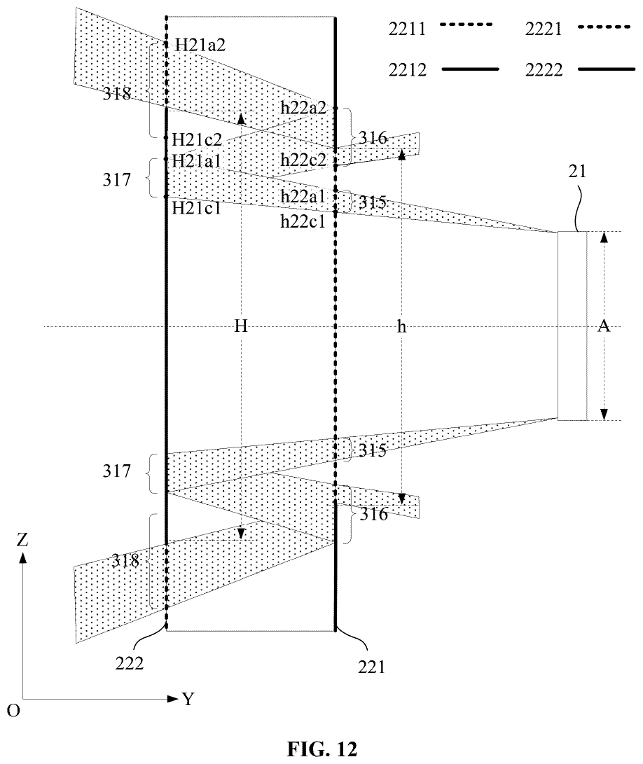

FIG. 9 to FIG. 13 show five types of dimensional design schematics for transmission and reflection of a near-eye display assembly according to an embodiment of the present disclosure. Referring to FIG. 9, according to the definition of each projection region, it can be understood that in the first plane YOZ, setting H21c1<H/2<H21c2 just means that the height of the boundary point of the second reflection region 2222 is between H21c1 and H21c2 when the position of the optical axis is taken as the origin, thereby ensuring that in the light beam emitted from the edge point of the display screen 21, light rays close to the optical axis can be reflected when they reach the second catadioptric surface 222 for the first time, and transmitted when they reach the second catadioptric surface 222 for the second time; moreover, setting h22c1<h/2<h22c2 just means that the height of the boundary point of the first transmission region 2211 is between h22c1 and h22c2 when the position of the optical axis is taken as the origin, thereby ensuring that in the light beam emitted from the edge point of the display screen 21, light rays close to the optical axis can be transmitted when they reach the first catadioptric surface 221 for the first time, and reflected when they reach the first catadioptric surface 221 for the second time; thus, the size ranges of the second reflection region 2222 and the first transmission region 2211 ensure that in the light beam emitted from the edge point of the display screen 21, light rays close to the optical axis can be reflexed, so as to enter the human eye for imaging.

Or, H21a1<H/2<H21a2, h22a1<h/2<h22a2; where H21a1 denotes the distance between the point, farthest from the optical axis, of the third edge projection region 313 in the first plane YOZ, H21a2 denotes the distance between the point, farthest from the optical axis, of the fourth edge projection region 314 in the first plane YOZ; h22a1 denotes the distance between the point, farthest from the optical axis, of the first edge projection region 311 in the first plane YOZ; and h22a2 denotes the distance between the point, farthest from the optical axis, of the second edge projection region 312 in the first plane YOZ.

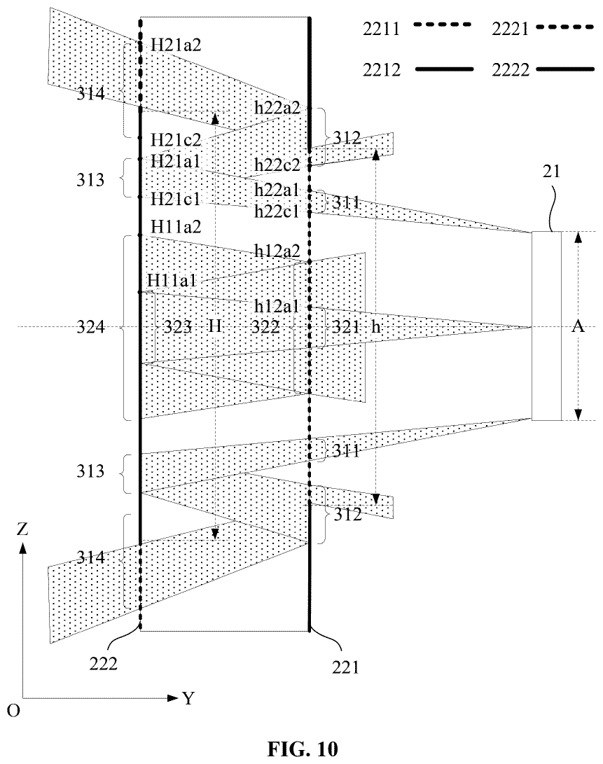

Referring to FIG. 10, according to the definition of each projection region, it can be understood that in the first plane YOZ, setting H21a1<H/2<H21a2 just means that the height of the boundary point of the second reflection region 2222 is between H21a1 and H21a2 when the position of the optical axis is taken as the origin, thereby ensuring that in the light beam emitted from the edge point of the display screen 21, light rays farthest from the optical axis can be reflected when they reach the second catadioptric surface 222 for the first time, and transmitted when they reach the second catadioptric surface 222 for the second time; moreover, setting h22a1<h/2<h22a2 just means that the height of the boundary point of the first transmission region 2211 is between h22a1 and h22a2 when the position of the optical axis is taken as the origin, thereby ensuring that in the light beam emitted from the edge point of the display screen 21, light rays farthest from the optical axis can be transmitted when they reach the first catadioptric surface 221 for the first time, and reflected when they reach the first catadioptric surface 221 for the second time; thus, the size ranges of the second reflection region 2222 and the first transmission region 2211 ensure that in the light beam emitted from the edge point of the display screen 21, light rays farthest from the optical axis can be reflexed, so as to enter the human eye for imaging.

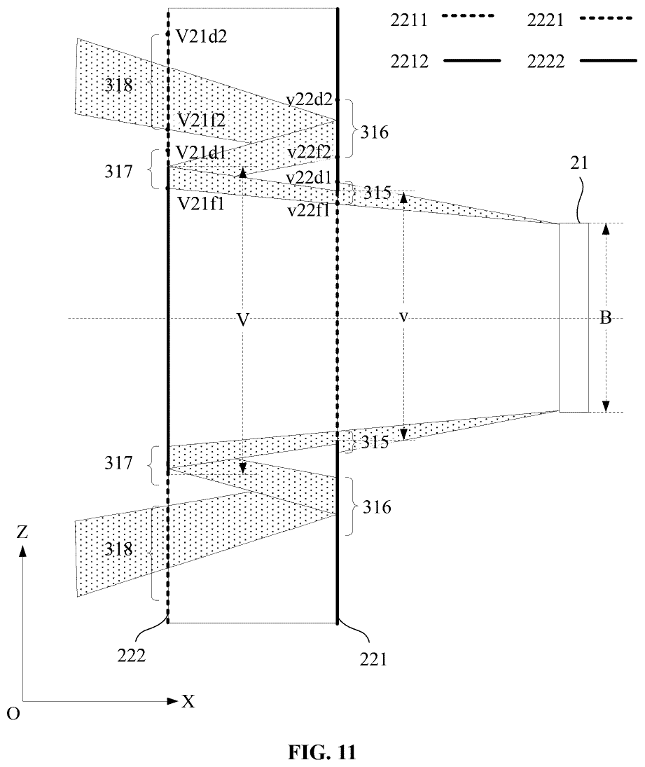

Similarly, further, referring to FIG. 11, V21f1<V/2<V21f2, and v22f1<v/2<v22f2. V21f1 denotes the distance between the point, closest to the optical axis, of the seventh edge projection region 317 in the second plane XOZ. V21f2 denotes the distance between the point, closest to the optical axis, of the eighth edge projection region 318 in the second plane XOZ. v22f1 denotes the distance between the point, closest to the optical axis, of the fifth edge projection region 315 in the second plane XOZ, and v22f2 denotes the distance between the point, closest to the optical axis, of the sixth edge projection region 316 in the second plane XOZ.

Referring to FIG. 11, according to the definition of each projection region, it can be understood that in the second plane XOZ, setting V21f1<V/2<V21f2 just means that the height of the boundary point of the second reflection region 2222 is between V21f1 and V21f2 when the position of the optical axis is taken as the origin, thereby ensuring that in the light beam emitted from the edge point of the display screen 21, light rays closest to the optical axis can be reflected when they reach the second catadioptric surface 222 for the first time, and transmitted when they reach the second catadioptric surface 222 for the second time; moreover, setting v22f1<v/2<v22f2 just means that the height of the boundary point of the first transmission region 2211 is between v22f1 and v22f2 when the position of the optical axis is taken as the origin, thereby ensuring that in the light beam emitted from the edge point of the display screen 21, light rays closest to the optical axis can be transmitted when they reach the first catadioptric surface 221 for the first time, and reflected when they reach the first catadioptric surface 221 for the second time; thus, the size ranges of the second reflection region 2222 and the first transmission region 2211 ensure that in the light beam emitted from the edge point of the display screen 21, light rays closest to the optical axis can be reflexed, so as to enter the human eye for imaging.

Alternatively, V21d1<V/2<V21d2, and v22d1<v/2<v22d2. V21d1 denotes the distance between the point, farthest from the optical axis, of the seventh edge projection region 317 in the second plane XOZ. V21d2 denotes the distance between the point, farthest from the optical axis, of the eighth edge projection region 318 in the second plane XOZ. v22d1 denotes the distance between the point, farthest from the optical axis, of the fifth edge projection region 315 in the second plane XOZ. v22d2 denotes the distance between the point, farthest from the optical axis, of the sixth edge projection region 316 in the second plane XOZ.

Referring to FIG. 11, according to the definition of each projection region, it can be understood that in the second plane XOZ, setting V21d1<V/2<V21d2 just means that the height of the boundary point of the second reflection region 2222 is between V21d1 and V21d2 when the position of the optical axis is taken as the origin, thereby ensuring that in the light beam emitted from the edge point of the display screen 21, light rays farthest from the optical axis can be reflected when they reach the second catadioptric surface 222 for the first time, and transmitted when they reach the second catadioptric surface 222 for the second time; moreover, setting v22d1<v/2<v22d2 just means that the height of the boundary point of the first transmission region 2211 is between v22d1 and v22d2 when the position of the optical axis is taken as the origin, thereby ensuring that in the light beam emitted from the edge point of the display screen 21, light rays farthest from the optical axis can be transmitted when they reach the first catadioptric surface 221 for the first time, and reflected when they reach the first catadioptric surface 221 for the second time; thus, the size ranges of the second reflection region 2222 and the first transmission region 2211 ensure that in the light beam emitted from the edge point of the display screen 21, light rays farthest from the optical axis can be reflexed, so as to enter the human eye for imaging.

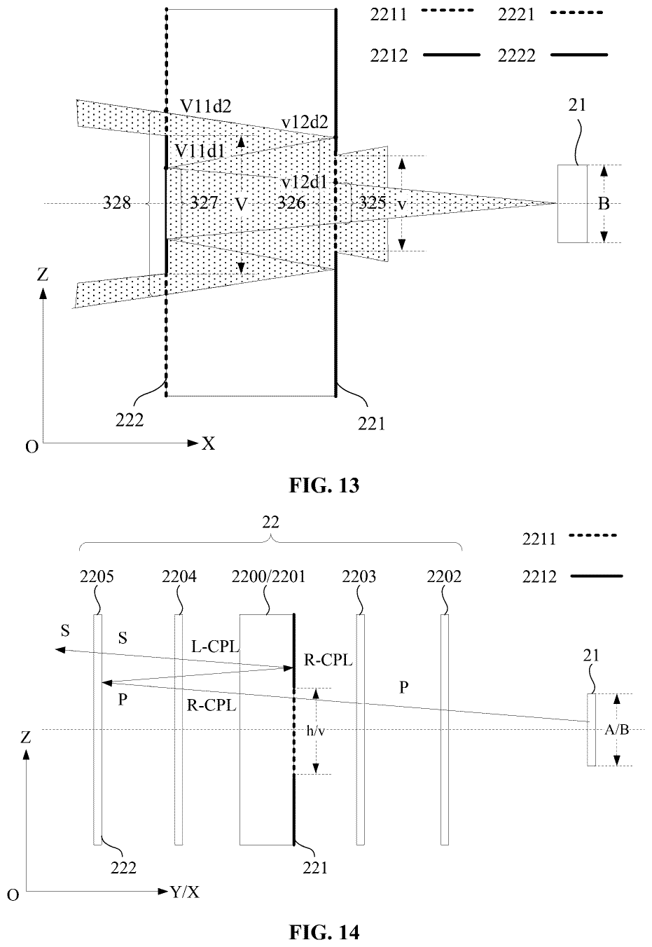

In addition, referring to FIG. 13, V11d1<V/2<V11d2, and v12d1<v/2<v12d2; where V11d1 denotes the distance between the point, farthest from the optical axis, of the seventh central projection region 327 in the second plane XOZ; V11d2 denotes the distance between the point, farthest from the optical axis, of the eighth central projection region 328 in the second plane XOZ; v12d1 denotes the distance between the point, farthest from the optical axis, of the fifth central projection region 325 in the second plane XOZ; and v12d2 denotes the distance between the point, farthest from the optical axis, of the sixth central projection region 326 in the second plane XOZ.

Referring to FIG. 13, according to the definition of each projection region, it can be understood that in the second plane XOZ, setting V11d1<V/2<V11d2 just means that the height of the boundary point of the second reflection region 2222 is between V11d1 and V11d2 when the position of the optical axis is taken as the origin, thereby ensuring that in the light beam emitted from the center point of the display screen 21, light rays farthest from the optical axis can be reflected when they reach the second catadioptric surface 222 for the first time, and transmitted when they reach the second catadioptric surface 222 for the second time; moreover, setting v12d1<v/2<v12d2 just means that the height of the boundary point of the first transmission region 2211 is between v12d1 and v12d2 when the position of the optical axis is taken as the origin, thereby ensuring that in the light beam emitted from the center point of the display screen 21, light rays farthest from the optical axis can be transmitted when they reach the first catadioptric surface 221 for the first time, and reflected when they reach the first catadioptric surface 221 for the second time; thus, the size ranges of the second reflection region 2222 and the first transmission region 2211 ensure that in the light beam emitted from the center point of the display screen 21, light rays farthest from the optical axis can be reflexed, so as to enter the human eye for imaging.

In summary, by limiting the size ranges of the second reflection region 2222 and the first transmission region 2211, it can be ensured that in the two dimensions of the first plane YOZ and the second plane XOZ, at least part of the light rays in the light beam emitted from the edge point of the display screen 21 can be reflected, thereby entering the human eye for imaging. Moreover, it can further ensure that at least part of the light rays in the light beam emitted from the center point of the display screen 21 can also be reflected at least in the second plane XOZ dimension, and can be incident on the human eye for imaging. In other words, in this embodiment, by differentially setting the sizes of the second reflection region 2222 and the first transmission region 2211 in the first plane YOZ and the second plane XOZ dimensions, the sizes of the two regions in the second plane XOZ dimension are controlled to be smaller than the sizes in the first plane YOZ dimension, so that the light rays from the center point of the display screen 21 can be reflexed in the second plane XOZ dimension and projected into the human eye, thereby avoiding the problem that the second reflection region 2222 on the second catadioptric surface 222 in the reflexing structure blocks the light which results in the central region of the display screen 21 being unable to be imaged into the human eye.

Further optionally, in the embodiment of the present disclosure, the projections of the first transmission region 2211 and the second reflection region 2222 in the optical axis direction can be set to have a same shape, and the shape includes rectangular, elliptical or irregular polygonal. Taking the rectangular shape as an example, the long side direction of the first transmission region 2211 and the second reflection region 2222 is the Y-axis direction, and the short side direction is the X-axis direction; and taking the elliptical shape as an example, the long side direction of the first transmission region 2211 and the second reflection region 2222 is the Y-axis direction, and the short side direction is the X-axis direction.

FIG. 14 is a schematic diagram of an equivalent structure of another near-eye display assembly according to an embodiment of the present disclosure in the YOZ plane. Referring to FIG. 14, in another embodiment, the refraction and reflection imaging system 22 includes a transmissive polarizer 2202, a first quarter-wave plate 2203, a lens subsystem 2200, a second quarter-wave plate 2204 and a reflective polarizer 2205 arranged in sequence along the optical axis.

The lens subsystem 2200 includes at least a first lens 2201, and the first catadioptric surface 221 is located on an object side surface of the first lens 2201; the first catadioptric surface 221 includes a first transmission region 2211 and a first reflection region 2212, and the first reflection region 2212 surrounds the first transmission region 2211; the second catadioptric surface 222 is located on the reflective polarizer 2205; and in the optical axis direction, the projection of the display screen 21 is located within the projection of the first transmission region 2211.

At least part of the light rays emitted from any position on the display screen 21 sequentially pass through the transmissive polarizer 2202, the first quarter wave plate 2203, the first transmission region 2211, the second quarter wave plate 2204, the reflective polarizer 2205, the second quarter wave plate 2204, the first reflection region 2212, the second quarter wave plate 2204, and the reflective polarizer 2205 to enter the in-coupling region 110 of the one-dimensional optical waveguide 10.

During transmission of the light rays from the display screen 21 to the in-coupling region 110 of the one-dimensional optical waveguide 10, horizontally polarized light P is formed after the light rays from the display screen 21 pass through the transmissive polarizer 2202, right-handed circularly polarized light R-CPL is formed after the light rays from the transmissive polarizer 2202 pass through the first quarter wave plate 2203, the horizontally polarized light P is formed after the light rays transmitted from the first transmission region 2211 pass through the second quarter wave plate 2204, light rays from the second quarter wave plate 2204 are reflected by the reflective polarizer 2205 to pass through the second quarter wave plate 2204 to form the right-handed circularly polarized light R-CPL, the left-handed circularly polarized light L-CPL is formed after the light rays from the second quarter wave plate 2204 are reflected by the first reflection region 2212, vertical polarized light S is formed after the light rays reflected by the first reflection region 2212 pass through the second quarter wave plate 2204, and finally the light rays from the second quarter wave plate 2204 are transmitted through the reflective polarizer 2204 to the in-coupling region 110 of the one-dimensional optical waveguide 10.

The refraction and reflection imaging system 22 in this embodiment is essentially a Polarization Reflective-Refractive System, in which the lens subsystem 2200 is also mainly responsible for converging the light into an image. Further, the lens in the lens subsystem 2200 is provided with corresponding transmission regions and reflection regions, which cooperate with the polarization and analysis structures to control the transmission or reflection process of the lens surface to the light rays. Optionally, there is a first lens 2201 in the lens subsystem 2200, and a transmission region and a reflection region are set on the object side surface of the first lens 2201. Of course, in other embodiments of the present disclosure, also optionally, the lens subsystem 2200 includes more than one lens, so that the first catadioptric surface 221 forming the transmission and reflection can be located on the surface of any lens.

Specifically, optionally, the first transmission region 2211 of the object side surface of the first lens 2201 is provided with a first transmission film, and the first reflection region 2212 is provided with a first reflection film. The transmission film refers to an enhanced transmission film or an anti-reflection film, which can enhance the transmittance of light rays through the surface. The reflection film can be a metal film, etc., which can avoid the transmission of light rays and increase the reflectivity.

Similarly, in order to ensure effective transmission and reflection so that the image displayed on the display screen 21 can effectively enter the human eye, it is further provided in this embodiment a regional range setting scheme for the transmission region and the reflection region on the first catadioptric surface. For the corresponding naming rules, reference may be made to the previous embodiment and they will not be repeated here.

Specifically, the refraction and reflection imaging system 22 includes a first plane YOZ and a second plane XOZ, the first plane YOZ and the second plane XOZ are perpendicular to each other and intersect at the optical axis of the refraction and reflection imaging system 22. Each of the first transmission region 2211 and the first reflection region 2212 is self-symmetrical relative to the first plane YOZ, and is also self-symmetrical relative to the second plane XOZ.

It should be noted that, since in this embodiment, the polarization reflective-refractive principle is adopted, on the second catadioptric surface 222, i.e., the reflective polarizer 2205, parallel polarized light is reflected and vertical polarized light is transmitted, rather than the reflection film and the transmission film being selected for reflection and transmission, the light rays incident on the second catadioptric surface 222 will not be blocked. Therefore, whether the light rays are transmitted or reflected depends mainly on the size setting of the transmission region and the reflection region on the first catadioptric surface 221.

Based on this, the sizes of the transmission region and the reflection region on the first catadioptric surface are defined as follows: h>A; v>B. h denotes the length of the intersection line between the first transmission region and the first plane. A denotes the length of the intersection line between the display screen and the first plane. v denotes the length of the intersection line between the first transmission region and the second plane. B denotes the length of the intersection line between the display screen and the second plane.

Continuing to refer to FIG. 14, it can be understood that in the first plane YOZ, when h>A, it means that the length of the first transmission region 2211 is greater than the length of the display screen 21, thereby ensuring that all the light rays emitted from the display screen 21 can be transmitted when they are first projected onto the first catadioptric surface 221. Similarly, it can be understood that in the second plane XOZ, when v>B, it means that the length of the first transmission region 2211 is greater than the length of the display screen 21, thereby ensuring that all the light rays emitted from the display screen 21 can be transmitted when they are first projected onto the first catadioptric surface 221.

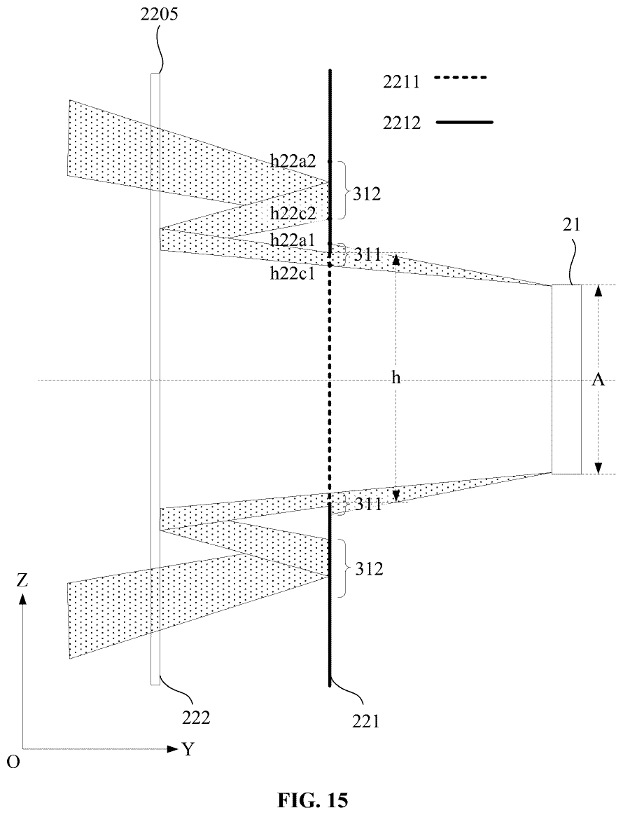

Further, referring to FIG. 15, h22c1<h/2<h22c2; where h22c1 denotes the distance between the point, closest to the optical axis, of the first edge projection region 311 in the first plane YOZ, and h22c2 denotes the distance between the point, closest to the optical axis, of the second edge projection region 312 in the first plane YOZ.

FIG. 15 to FIG. 20 show six types of dimensional design schematics for transmission and reflection of the near-eye display assembly according to the embodiment of the present disclosure. Referring to FIG. 15, according to the definition of each projection region, it can be understood that in the first plane YOZ, setting h22c1<h/2<h22c2 just means that the height of the boundary point of the first transmission region 2211 is between h22c1 and h22c2 when the position of the optical axis is taken as the origin, thereby ensuring that in the light beam emitted from the edge point of the display screen 21, light rays close to the optical axis can be transmitted when they reach the first catadioptric surface 221 for the first time, and reflected when they reach the first catadioptric surface 221 for the second time; thus, the size range of the first transmission region 2211 ensures that in the light beam emitted from the edge point of the display screen 21, light rays close to the optical axis can be reflexed, so as to enter the human eye for imaging.

Alternatively, h22a1<h/2<h22a2. h22a1 denotes the distance between the point, farthest from the optical axis, of the first edge projection region 311 in the first plane YOZ. h22a2 denotes the distance between the point, farthest from the optical axis, of the second edge projection region 312 in the first plane YOZ.

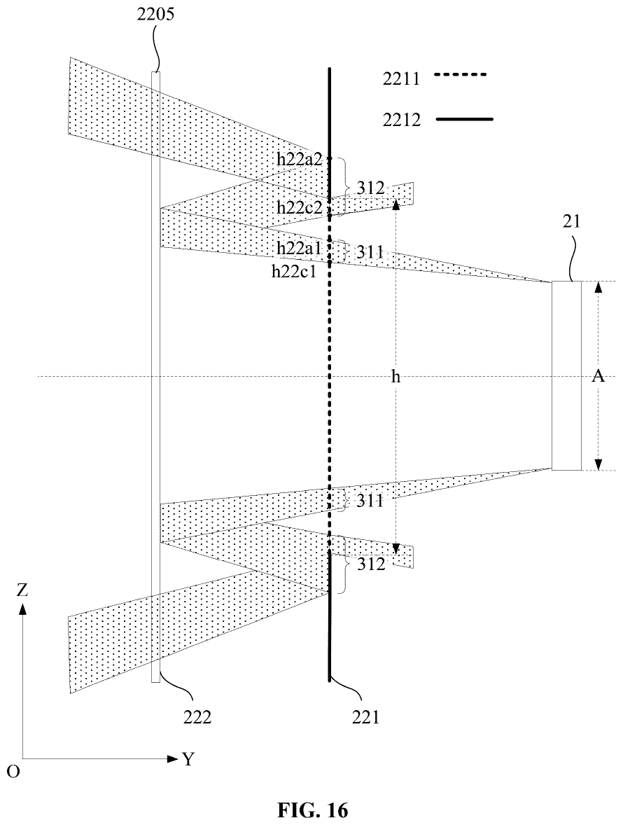

Referring to FIG. 16, according to the definition of each projection region, it can be understood that in the first plane YOZ, setting h22a1<h/2<h22a2 just means that the height of the boundary point of the first transmission region 2211 is between h22a1 and h22a2 when the position of the optical axis is taken as the origin, thereby ensuring that in the light beam emitted from the edge point of the display screen 21, light rays farthest from the optical axis can be transmitted when they reach the first catadioptric surface 221 for the first time, and reflected when they reach the first catadioptric surface 221 for the second time; thus, the size range of the first transmission region 2211 ensures that in the light beam emitted from the edge point of the display screen 21, light rays farthest from the optical axis can be reflexed, so as to enter the human eye for imaging.

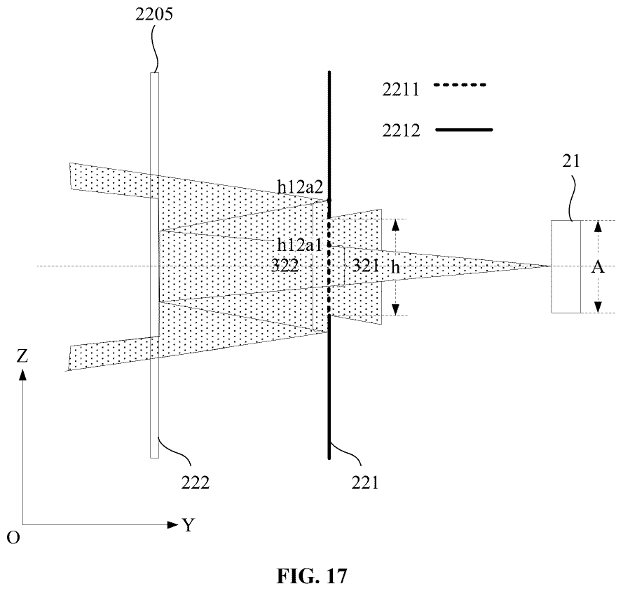

Further, referring to FIG. 17, h12a1<h/2<h12a2. h12a1 denotes the distance between the point, farthest from the optical axis, of the first central projection region 321 in the first plane YOZ. h12a2 denotes the distance between the point, farthest from the optical axis, of the second central projection region 322 in the first plane YOZ.

Referring to FIG. 17, according to the definition of each projection region, it can be understood that in the first plane YOZ, setting h12a1<h/2<h12a2 means that the height of the boundary point of the first transmission region 2211 is between h12a1 and h12a2 when the position of the optical axis is taken as the origin, thereby ensuring that in the light beam emitted from the center point of the display screen 21, the light rays farthest from the optical axis can be transmitted when they reach the first catadioptric surface 221 for the first time, and reflected when they reach the first catadioptric surface 221 for the second time; thus, the size range of the first transmission region 2211 ensures that in the light beam emitted from the edge point of the display screen 21, light rays farthest from the optical axis can be reflexed, so as to enter the human eye for imaging.

Similarly, v22f1<v/2<v22f2. v22f1 denotes the distance between the point, closest to the optical axis, of the fifth edge projection region 315 in the second plane XOZ. v22f2 denotes the distance between the point, closest to the optical axis, of the sixth edge projection region 316 in the second plane XOZ.

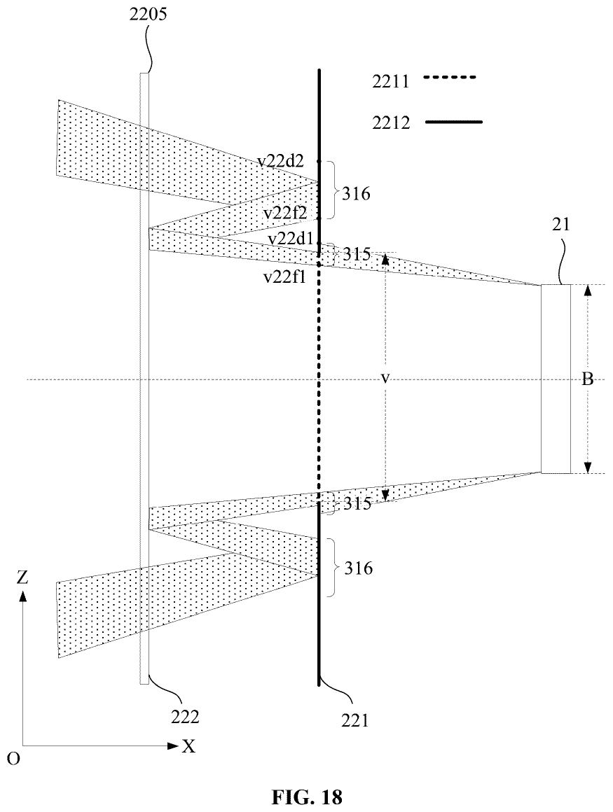

Referring to FIG. 18, according to the definition of each projection region, it can be understood that in the second plane XOZ, setting v22f1<v/2<v22f2 just means that the height of the boundary point of the first transmission region 2211 is between v22f1 and v22f2 when the position of the optical axis is taken as the origin, thereby ensuring that in the light beam emitted from the edge point of the display screen 21, light rays closest to the optical axis can be transmitted when they reach the first catadioptric surface 221 for the first time, and reflected when they reach the first catadioptric surface 221 for the second time; thus, the size range of the first transmission region 2211 ensures that in the light beam emitted from the edge point of the display screen 21, light rays closest to the optical axis can be reflexed, so as to enter the human eye for imaging.

Alternatively, v22d1<v/2<v22d2. v22d1 denotes the distance between the point, farthest from the optical axis, of the fifth edge projection region 315 in the second plane XOZ. v22d2 denotes the distance between the point, farthest from the optical axis, of the sixth edge projection region 316 in the second plane XOZ.

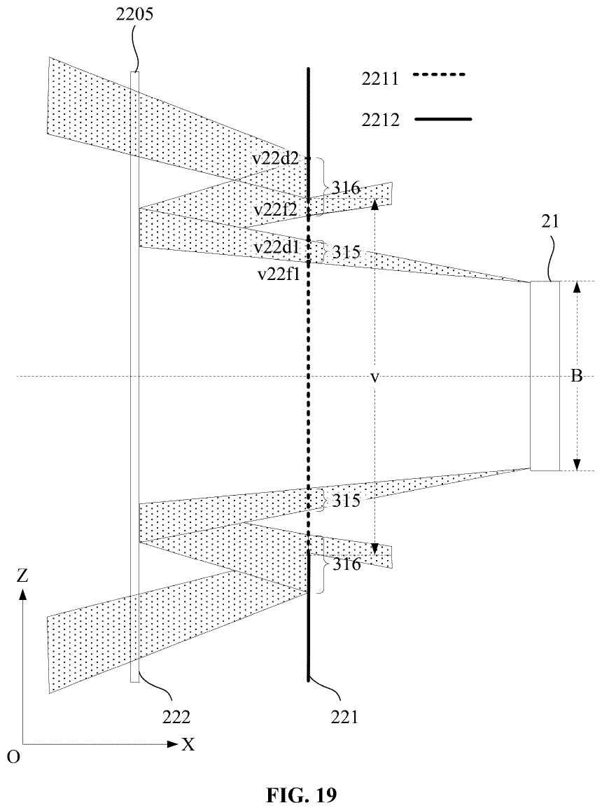

Referring to FIG. 19, according to the definition of each projection region, it can be understood that in the second plane XOZ, setting v22d1<v/2<v22d2 just means that the height of the boundary point of the first transmission region 2211 is between v22d1 and v22d2 when the position of the optical axis is taken as the origin, thereby ensuring that in the light beam emitted from the edge point of the display screen 21, light rays farthest from the optical axis can be transmitted when they reach the first catadioptric surface 221 for the first time, and reflected when they reach the first catadioptric surface 221 for the second time; thus, the size range of the first transmission region 2211 ensures that in the light beam emitted from the edge point of the display screen 21, light rays farthest from the optical axis can be reflexed, so as to enter the human eye for imaging.

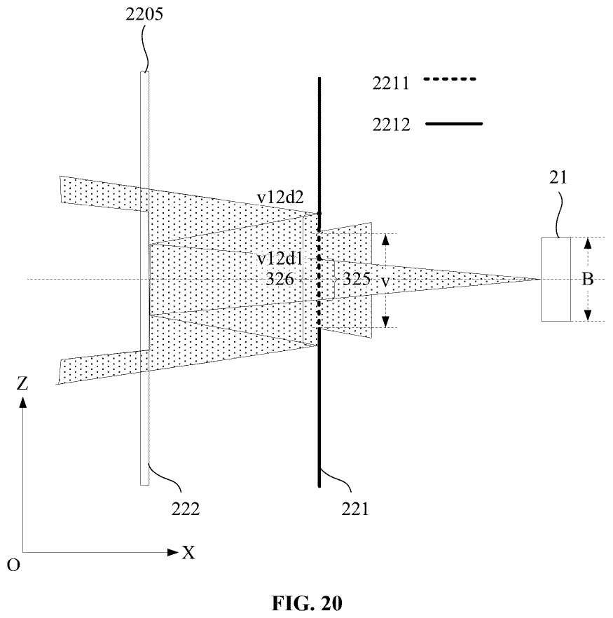

Further, referring to FIG. 20, v12d1<v/2<v12d2. v12d1 denotes the distance between the point, farthest from the optical axis, of the fifth central projection region 325 in the second plane XOZ; and v12d2 denotes the distance between the point, farthest from the optical axis, of the sixth central projection region 326 in the second plane XOZ.

Referring to FIG. 20, according to the definition of each projection region, it can be understood that in the second plane XOZ, setting v12d1<v/2<v12d2 just means that the height of the boundary point of the first transmission region 2211 is between v12d1 and v12d2 when the position of the optical axis is taken as the origin, thereby ensuring that in the light beam emitted from the center point of the display screen 21, light rays farthest from the optical axis can be transmitted when they reach the first catadioptric surface 221 for the first time, and reflected when they reach the first catadioptric surface 221 for the second time; thus, the size range of the first transmission region 2211 ensures that in the light beam emitted from the center point of the display screen 21, light rays farthest from the optical axis can be reflected, so as to enter the human eye for imaging.

Optionally, in the above embodiments, the first lens 2201 in the lens subsystem 2200 can be set as a meniscus lens convex towards the display screen. The meniscus lens with positive focal power can meet the requirements of converging the light rays emitted from the display screen 21 and also completing internal reflex.

Optionally, in each of the above embodiments, the object side surface or image side surface of the first lens 2201 in the lens subsystem 2200 may be set to be a spherical surface, an aspherical surface, a free-form surface or a diffraction surface. By setting the specific surface morphology of the first lens 2201, various aberrations apt to be generated by the lens, such as distortion, field curvature, chromatic aberration, etc., can be corrected through the spherical surface, the aspherical surface, the free-form surface or the diffraction surface, so as to ensure the imaging quality of the near-eye display assembly and avoid display image distortion.

Note that the above are only preferred embodiments of the present disclosure and the technical principles used. The person skilled in the art will understand that the present disclosure is not limited to the specific embodiments described herein, and that various obvious changes, readjustments, combinations and substitutions can be made by those skilled in the art without departing from the scope of protection of the present disclosure. Therefore, although the present disclosure is described in detail through the above embodiments, the present disclosure is not limited to the above embodiments, and may include more other equivalent embodiments without departing from the concept of the present disclosure, and the scope of the present disclosure is determined by the scope of the appended claims.

What is claimed is:

1. A near-eye display assembly, comprising:
a one-dimensional optical waveguide comprising an in-coupling region and an out-coupling region which are arranged in a first direction, wherein the first direction is a pupil expansion direction of the one-dimensional optical waveguide; and
an optical system arranged towards the in-coupling region of the one-dimensional optical waveguide;
wherein the optical system comprises a display screen and a refraction and reflection imaging system, the refraction and reflection imaging system is located on a light-emitting side of the display screen, and the display screen is located on an object side focal plane of the refraction and reflection imaging system,
wherein the refraction and reflection imaging system comprises a first catadioptric surface and a second catadioptric surface which are arranged along an optical axis, at least part of light rays emitted from any position on the display screen are transmitted through the first catadioptric surface to the second catadioptric surface, reflected from the second catadioptric surface to the first catadioptric surface, reflected from the first catadioptric surface to the second catadioptric surface, and transmitted through the second catadioptric surface to the in-coupling region of the one-dimensional optical waveguide in sequence.

2. The near-eye display assembly according to claim 1, wherein,
the refraction and reflection imaging system comprises a lens subsystem, the lens subsystem comprises at least a first lens, the first catadioptric surface is located on an object side surface of the first lens, and the second catadioptric surface is located on an image side surface of the first lens;
the first catadioptric surface comprises a first transmission region and a first reflection region, and the first reflection region surrounds the first transmission region;
the second catadioptric surface comprises a second transmission region and a second reflection region, and the second transmission region surrounds the second reflection region;
along an optical axis direction, a projection of the display screen is located within a projection of the first transmission region, and the projection of the first transmission region is located within a projection of the second reflection region; and
at least part of the light rays emitted from any position on the display screen are transmitted through the first transmission region to the second reflection region, reflected from the second reflection region to the first reflection region, reflected from the first reflection region to the second transmission region, and transmitted through the second transmission region to the in-coupling region of the one-dimensional optical waveguide.

3. The near-eye display assembly according to claim 2, wherein,
the first transmission region of the object side surface of the first lens is provided with a first transmission film, and the first reflection region is provided with a first reflection film; and
the second transmission region of the image side surface of the first lens is provided with a second transmission film, and the second reflection region is provided with a second reflection film.

4. The near-eye display assembly according to claim 2, wherein the refraction and reflection imaging system comprises a first plane and a second plane, and the first plane and the second plane are perpendicular to each other and intersect at the optical axis of the refraction and reflection imaging system; and
each of the first transmission region, the first reflection region, the second transmission region and the second reflection region is self-symmetrical relative to the first plane, and is also self-symmetrical relative to the second plane; wherein,
h>A; H21c1<H/2<H21a2;
A denotes a length of an intersection line between the display screen and the first plane;
h denotes a length of an intersection line between the first transmission region and the first plane, and H denotes a length of an intersection line between the second reflection region and the first plane;
H21c1 denotes a distance between the optical axis and a point, closest to the optical axis, of a third edge projection region in the first plane, and the third edge projection region is a projection region of an exit light beam, emitted from an edge point of the display screen on the first plane, on the second catadioptric surface for a first time;
H21a2 denotes a distance between the optical axis and a point, farthest from the optical axis, of a fourth edge projection region in the first plane, and the fourth edge projection region is a projection region of an exit light beam, emitted from the edge point of the display screen on the first plane, on the second catadioptric surface for a second time;
v>B; V21f1<V/2<V21d2, and D<V<D₀; wherein,
B denotes a length of an intersection line between the display screen and the second plane;
v denotes a length of an intersection line between the first transmission region and the second plane, and V denotes a length of an intersection line between the second reflection region and the second plane;
V21f1 denotes a distance between the optical axis and a point, closest to the optical axis, of a seventh edge projection region in the second plane, and the seventh edge projection region is a projection region of an exit light beam, emitted from an edge point of the display screen on the second plane, on the second catadioptric surface for the first time;
V21d2 denotes a distance between the optical axis and a point, farthest from the optical axis, of an eighth edge projection region in the second plane, and the eighth edge projection region is a projection region of the exit light beam, emitted from an edge point of the display screen on the second plane, on the second catadioptric surface for the second time; and
D denotes a diameter of a field of view formed by an exit light beam, from an edge point farthest, from a center point on the display screen, through the lens subsystem on the image side focal plane; and D₀ denotes a diameter of a field of view formed by an exit light beam, from the center point on the display screen, through the lens subsystem on the image side focal plane.

5. The near-eye display assembly according to claim 4, wherein,
H21c1<H/2<H21c2, and h22c1<h/2<h22c2; or, H21a1<H/2<H21a2, h22a1<h/2<h22a2; wherein,
H21c1 denotes a distance between the optical axis and a point, closest to the optical axis, of the third edge projection region in the first plane, and the third edge projection region is a projection region of an exit light beam, emitted from an edge point of the display screen on the first plane, on the second catadioptric surface for the first time;
H21c2 denotes a distance between the optical axis and a point, closest to the optical axis, of the fourth edge projection region in the first plane, and the fourth edge projection region is a projection region of an exit light beam, emitted from an edge point of the display screen on the first plane, on the second catadioptric surface for the second time;
h22c1 denotes a distance between the optical axis and a point, closest to the optical axis, of a first edge projection region in the first plane, and the first edge projection region is a projection region of an exit light beam, emitted from an edge point of the display screen on the first plane, on the first catadioptric surface for the first time;
h22c2 denotes a distance between the optical axis and a point, closest to the optical axis, of a second edge projection region in the first plane; and the second edge projection region is a projection region of an exit light beam, emitted from an edge point of the display screen on the first plane, on the first catadioptric surface for the second time;
H21a1 denotes a distance between the optical axis and a point, farthest from the optical axis, of the third edge projection region in the first plane;
H21a2 denotes a distance between the optical axis and a point, farthest from the optical axis, of the fourth edge projection region in the first plane;
h22a1 denotes a distance between the optical axis and a point, farthest from the optical axis, of the first edge projection region in the first plane; and
h22a2 denotes a distance between the optical axis and a point, farthest from the optical axis, of the second edge projection region in the first plane.

6. The near-eye display assembly according to claim 4, wherein,
V21f1<V/2<V21f2, and v22f1<v/2<v22f2; or, V21d1<V/2<V21d2, and v22d1<v/2<v22d2;
V21f1 denotes a distance between the optical axis and a point, closest to the optical axis, of the seventh edge projection region in the second plane, and the seventh edge projection region is a projection region of an exit light beam, emitted from an edge point of the display screen on the second plane, on the second catadioptric surface for the first time;
V21f2 denotes a distance between the optical axis and a point, closest to the optical axis, of the eighth edge projection region in the second plane; and the eighth edge projection region is a projection region of an exit light beam, emitted from an edge point of the display screen on the second plane, on the second catadioptric surface for the second time;
v22f1 denotes a distance between the optical axis and a point, closest to the optical axis, of a fifth edge projection region in the second plane; and the fifth edge projection region is a projection region of an exit light beam, emitted from an edge point of the display screen on the second plane, on the first catadioptric surface for the first time;
v22f2 denotes a distance between the optical axis and a point, closest to the optical axis, of a sixth edge projection region in the second plane; and the sixth edge projection region is a projection region of an exit light beam, emitted from an edge point of the display screen on the second plane, on the first catadioptric surface for the second time;
V21d1 denotes a distance between the optical axis and a point, farthest from the optical axis, of the seventh edge projection region in the second plane;
V21d2 denotes a distance between the optical axis and a point, farthest from the optical axis, of the eighth edge projection region in the second plane;
v22d1 denotes a distance between the optical axis and a point, farthest from the optical axis, of the fifth edge projection region in the second plane; and
v22d2 denotes a distance between the optical axis and a point, farthest from the optical axis, of the sixth edge projection region in the second plane;
V11d1<V/2<V11d2, and v12d1<v/2<v12d2; wherein,
V11d1 denotes a distance between the optical axis and a point, farthest from the optical axis, of a seventh central projection region in the second plane; and the seventh central projection region is a projection region of an exit light beam, emitted from the center point of the display screen on the second plane, on the second catadioptric surface for the first time;
V11d2 denotes a distance between the optical axis and a point, farthest from the optical axis, of an eighth central projection region in the second plane; and the eighth central projection region is a projection region of an exit light beam, emitted from the center point of the display screen on the second plane, on the second catadioptric surface for the second time;
v12d1 denotes a distance between the optical axis and a point, farthest from the optical axis, of a fifth central projection region in the second plane; and the fifth central projection region is a projection region of an exit light beam, emitted from the center point of the display screen on the second plane, on the first catadioptric surface for the first time; and
v12d2 denotes a distance between the optical axis and a point, farthest from the optical axis, of a sixth central projection region in the second plane.

7. The near-eye display assembly according to claim 4, wherein 2 mm<D<8 mm, and 2 mm<D₀<8 mm.

8. The near-eye display assembly according to claim 2, wherein projections of the first transmission region and the second reflection region in the optical axis direction have a same shape, and the shape comprises rectangular, elliptical or irregular polygonal.

9. The near-eye display assembly according to claim 1, wherein the refraction and reflection imaging system comprises a transmissive polarizer, a first quarter-wave plate, a lens subsystem, a second quarter-wave plate and a reflective polarizer arranged in sequence along the optical axis;
the lens subsystem at least comprises a first lens, and the first catadioptric surface is located on an object side surface of the first lens;
the first catadioptric surface comprises a first transmission region and a first reflection region, the first reflection region surrounds the first transmission region, and the second catadioptric surface is located on the reflective polarizer;
in the optical axis direction, a projection of the display screen is located within a projection of the first transmission region; and
at least part of the light rays emitted from any position on the display screen sequentially pass through the transmissive polarizer, the first quarter wave plate, the first transmission region, the second quarter wave plate, the reflective polarizer, the second quarter wave plate, the first reflection region, the second quarter wave plate, and the reflective polarizer to enter the in-coupling region of the one-dimensional optical waveguide;
during transmission of the light rays from the display screen to the in-coupling region of the one-dimensional optical waveguide, horizontally polarized light is formed after the light rays from the display screen pass through the transmissive polarizer, right-handed circularly polarized light is formed after the light rays from the transmissive polarizer pass through the first quarter wave plate, the horizontally polarized light is formed after the light rays transmitted from the first transmission region pass through the second quarter wave plate, light rays from the second quarter wave plate are reflected by the reflective polarizer to pass through the second quarter wave plate to form the right-handed circularly polarized light, the left-handed circularly polarized light is formed after the light rays from the second quarter wave plate are reflected by the first reflection region, vertical polarized light is formed after the light rays reflected by the first reflection region pass through the second quarter wave plate, and finally the light rays from the second quarter wave plate are transmitted through the reflective polarizer to the in-coupling region of the one-dimensional optical waveguide.

10. The near-eye display assembly according to claim 9, wherein,
the first transmission region of the object side surface of the first lens is provided with a first transmission film, and the first reflection region is provided with a first reflection film.

11. The near-eye display assembly according to claim 9, wherein,
the refraction and reflection imaging system comprises a first plane and a second plane, and the first plane and the second plane are perpendicular to each other and intersect at the optical axis of the refraction and reflection imaging system; and
each of the first transmission region and the first reflection region is self-symmetrical relative to the first plane, and is also self-symmetrical relative to the second plane; wherein:
h>A; v>B; wherein,
h denotes a length of an intersection line between the first transmission region and the first plane;
A denotes a length of an intersection line between the display screen and the first plane;
v denotes a length of an intersection line between the first transmission region and the second plane; and
B denotes a length of an intersection line between the display screen and the second plane.

12. The near-eye display assembly according to claim 11, wherein,
h22c1<h/2<h22c2; or, h22a1<h/2<h22a2; wherein,
h22c1 denotes a distance between the optical axis and a point, closest to the optical axis, of a first edge projection region in the first plane; and the first edge projection region is a projection region of an exit light beam, emitted from an edge point of the display screen on the first plane, on the first catadioptric surface for the first time;
h22c2 denotes a distance between the optical axis and a point, closest to the optical axis, of a second edge projection region in the first plane; and the second edge projection region is a projection region of an exit light beam, emitted from an edge point of the display screen on the first plane, on the first catadioptric surface for the second time;
h22a1 denotes a distance between the optical axis and a point, farthest from the optical axis, of the first edge projection region in the first plane; and the first edge projection region is a projection region of an exit light beam, emitted from an edge point of the display screen on the first plane, on the first catadioptric surface for the first time;
h22a2 denotes a distance between the optical axis and a point, farthest from the optical axis, of the second edge projection region in the first plane; and the second edge projection region is a projection region of an exit light beam, emitted from an edge point of the display screen on the first plane, on the first catadioptric surface for the second time;
h12a1<h/2<h12a2; wherein,
h12a1 denotes a distance between the optical axis and a point, farthest from the optical axis, of a first central projection region in the first plane; and the first central projection region is a projection region of an exit light beam, emitted from a center point of the display screen on the first plane, on the first catadioptric surface for the first time; and
h12a2 denotes a distance between the optical axis and a point, farthest from the optical axis, of a second central projection region in the first plane; and the second central projection region is a projection region of an exit light beam, emitted from the center point of the display screen on the first plane, on the first catadioptric surface for the second time.

13. The near-eye display assembly according to claim 11, wherein,
v22f1<v/2<v22f2; or, v22d1<v/2<v22d2; wherein,
v22f1 denotes a distance between the optical axis and a point, closest to the optical axis, of a fifth edge projection region in the second plane; and the fifth edge projection region is a projection region of an exit light beam, emitted from an edge point of the display screen on the second plane, on the first catadioptric surface for the first time;
v22f2 denotes a distance between the optical axis and a point, closest to the optical axis, of a sixth edge projection region in the second plane; and the sixth edge projection region is a projection region of an exit light beam, emitted from an edge point of the display screen on the second plane, on the first catadioptric surface for the second time;
v22d1 denotes a distance between the optical axis and a point, farthest from the optical axis, of the fifth edge projection region in the second plane; and the fifth edge projection region is a projection region of an exit light beam, emitted from an edge point of the display screen on the second plane, on the first catadioptric surface for the first time; and
v22d2 denotes a distance between the optical axis and a point, farthest from the optical axis, of the sixth edge projection region in the second plane; and the sixth edge projection region is a projection region of an exit light beam, emitted from an edge point of the display screen on the second plane, on the first catadioptric surface for the second time;
v12d1<v/2<v12d2; wherein,
v12d1 denotes a distance between the optical axis and a point, farthest from the optical axis, of a fifth central projection region in the second plane; and the fifth central projection region is a projection region of an exit light beam, emitted from the center point of the display screen on the second plane, on the first catadioptric surface for the first time; and
v12d2 denotes a distance between the optical axis and a point, farthest from the optical axis, of a sixth central projection region in the second plane; and the sixth central projection region is a projection region of an exit light beam, emitted from the center point of the display screen on the second plane, on the first catadioptric surface for the second time.

14. The near-eye display assembly according to claim 2, wherein the first lens is a meniscus lens convex towards the display screen.

15. The near-eye display assembly according to claim 2, wherein the object side surface or the image side surface of the first lens is a spherical surface, an aspherical surface, a free-form surface or a diffraction surface.

16. The near-eye display assembly according to claim 1, wherein the refraction and reflection imaging system has positive focal power.

17. The near-eye display assembly according to claim 9, wherein the first lens is a meniscus lens convex towards the display screen.

18. The near-eye display assembly according to claim 9, wherein the object side surface or the image side surface of the first lens is a spherical surface, an aspherical surface, a free-form surface or a diffraction surface.
